(19) United States
(12) Patent Application Publication
(10) Pub. No.: US 2009/0022939 A1
(43) Pub. Date: Jan. 22, 2009

(54) Adhesive Film

(76) Inventors: Masami Yanagida, Shiga (JP); Kenji Ueshima, Hyogo (JP)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 12/224,918

(22) PCT Filed: Feb. 28, 2007
(86) PCT No.: PCT/JP2007/053716

§ 371 Date: Sep. 9, 2008

(30) Foreign Application Priority Data
Mar. 17, 2006 (JP) 2006-074708
May 10, 2006 (JP) 2006-131896

(51) Int. Cl. B32B 3/00

(52) U.S. Cl. 428/101

(57) ABSTRACT

An adhesive film, having lubricity, which can be favorably used as an FPC board even when a dense circuit pattern is formed is provided. The adhesive film is obtained by providing a highly heat-resistant polyimide layer and thermoplastic polyimide layers on both surfaces of the highly heat-resistant polyimide layer. The highly heat-resistant polyimide layer, serving as a central layer, has substantially no lubricant existing therein. Each of the thermoplastic polyimide layers has a lubricant, uniformly dispersed in the thermoplastic polyimide layer, which has a median average particle diameter of 1 μm to 10 μm. The lubricant existing in the thermoplastic polyimide layer is covered with a thermoplastic polyimide resin.

### TECHNICAL FIELD

The present invention relates to adhesive films each obtained by providing thermoplastic polyimide layers on both surfaces of a highly heat-resistant polyimide layer serving as a central layer or, in particular, an adhesive film, capable of achieving a reduction in lubricant with lubricity imparted thereto, which is free of minute blisters on metal foil thermally laminated thereon.

### BACKGROUND ART

In recent years, as electronic products have had lighter weights, smaller sizes, and higher densities, electronic components have been required to have smaller sizes and lighter weights. For this reason, among circuit boards on which electronic components are mounted, flexible laminates (flexible printed-circuit boards (FPCs); hereinafter referred to sometimes as “FPCs”) have been rapidly increasingly demanded in comparison with conventional rigid printed-circuit boards.

Generally, a flexible laminate is manufactured by a method for, using a flexible insulating film as a substrate, laminating metal foil on a surface of the substrate by heating and pressure bonding via various adhesive materials. Conventionally, in such flexible laminates (three-layer FPCs) each composed of three layers, namely an insulating film, an adhesive material, and metal foil, polyimide films or the like have been widely used as the insulating films. The reason for this is that a polyimide is excellent in heat resistance, electrical properties, and the like. Further, as the adhesive materials, thermosetting adhesives such as epoxy adhesives and acrylic adhesives are generally used.

A thermosetting adhesive for use in a three-layer FPC offers an advantage of enabling adhesion at a relatively low temperature. However, such a thermosetting adhesive is inferior in heat resistance. Therefore, a three-layer FPC manufactured with use of such a thermosetting adhesive has a problem of being poor in heat resistance as a whole. Further, such a thermosetting adhesive has a problem of containing a halogen-containing flame retardant unfriendly to the environment. Since an FPC will be stringently required in the future to have properties such as heat resistance, bendability, and electric reliability and to be made of a material reduced in burden on the environment, the reality is that a three-layer FPC manufactured with use of a thermosetting adhesive is experiencing difficulty in satisfying such stringent requirements.

Proposed in view of this is a flexible laminate (two-layer FPC) constituted by two layers, namely an insulating film and metal foil. Such a two-layer FPC has none of the problems resulting from adhesive materials, and therefore is expected to be a flexible laminate that meets the requirements. Known examples of a method for manufacturing a two-layer FPC include: a casting method for imidizing polyamic acid, serving as a polyimide precursor, which has been flow-cast and applied onto metal foil; a metalizing method for providing a metal layer directly on a polyimide film by sputtering or plating; and a laminating method for laminating a highly heat-resistant polyimide film and metal foil with a thermoplastic polyimide sandwiched therebetween. It should be noted that although such an FPC as manufactured with use of a thermoplastic polyimide and a highly heat-resistant polyimide can be said to be a three-layer FPC in a narrow sense, the FPC is regarded as a two-layer FPC by regarding two polyimide layers as one. Among these methods, the laminating method excels in being able to deal with a wider range of thickness of metal foil than the casting method. Further, the laminating method employs a laminating machine such as a heat-roller laminating machine or a double-belt pressing machine that continuously unrolls and laminates a roll of material, and therefore excels in being lower in apparatus cost than the metalizing method.

According to the laminating method for laminating a highly heat-resistant polyimide film and metal foil with a thermoplastic polyimide sandwiched therebetween, adhesive films each obtained by providing a thermoplastic polyimide layer on at least one surface of a highly heat-resistant polyimide film are widely used as substrate materials. Generally, such an adhesive film is manufactured by a coating method for coating one surface or both surfaces of a highly heat-resistant polyimide film with a thermoplastic polyimide or a precursor thereof in solution form and drying the highly heat-resistant polyimide film, or by a thermal laminating method for laminating a thermoplastic polyimide layer(s) on one surface or both surfaces of a highly heat-resistant polyimide film.

Such an adhesive film poses the challenge of imparting lubricity to a film surface. An adhesive film with no lubricity may get creases in it when wound or conveyed in process of manufacture. An adhesive film having creases in it cannot be neatly laminated on metal foil such as copper foil. Therefore, lubricity is an extremely important factor that has a direct influence on an adhesive film yield.

Conventionally known examples of a method for imparting lubricity to a surface of a polyimide film include a method (e.g., see Patent Document 1) for producing minute projections on a film surface by mixing a filler such as calcium phosphate. Specifically employed is a method for manufacturing a lubricative polyimide film by dispersing filler particles in advance in an organic polar solvent, by preparing a filler-dispersed polyamic acid solution with a mixture of the filler-dispersed organic polar solvent and a polymerization solvent of polyamic acid, a prepolymer solution, or a polyamic acid solution, and by flow-casting the solution onto a support and forming a film.

Proposed as another method for imparting lubricity to a surface of a polyimide film is a method (e.g., see Patent Document 2) for applying, over a surface of a film composed of aromatic polyamic acid and an organic polar solvent, a dispersion liquid prepared by dispersing inorganic particles in a low-boiling organic solvent, retaining the inorganic particles on the surface layer of the film by drying the dispersion liquid, and then treating the film with heat at a high temperature. Patent Document 2 teaches that a polyimide film to which lubricity has been imparted by such a method has a surface on which the inorganic particles are so retained as to be partially embedded in the surface and partially project from the surface and thereby form a large number of projections.

Patent Document 1: Japanese Unexamined Patent Application Publication No. 68852/1987 (Tokukaisho 62-68852; published on Mar. 28, 1987)
Patent Document 2: Japanese Unexamined Patent Application Publication No. 25295/1993 (Tokukaihei 5-25295; published on Feb. 2, 1993)

### DISCLOSURE OF INVENTION

### Problems to be Solved by the Invention

However, when applied to an adhesive film that is used to be laminated on metal foil, each of the methods of Patent Documents 1 and 2 for imparting lubricity has a problem with insufficient performance of a flexible laminate to be obtained.

That is, the method of Patent Document 1 disperses a filler, i.e., a lubricant entirely in a film, and therefore requires a large amount of lubricant. Moreover, the excessively high content of lubricant may exert an unfavorable influence on the properties of the film, and such an influence may be extended to the performance of a flexible laminate.

On the other hand, the method of Patent Document 2 retains inorganic particles, i.e., a lubricant on a surface layer of a film, and therefore does not require a large amount of lubricant, thereby solving the problems posed by the method of Patent Document 1. However, the method of Patent Document 2 has a problem with minute blisters on metal foil of a flexible laminate obtained by laminating the film on metal foil, i.e., with a minute area where the metal foil does not adhere to a thermoplastic polyimide layer of the adhesive film and therefore blisters.

That is, the method of Patent Document 2 for forming exposed projections of inorganic particles by applying and drying a dispersion liquid prepared by dispersing inorganic particles in a low-boiling organic solvent causes minute blisters on metal foil after the metal foil is laminated. Such minute blisters can be fatal defects in a situation where circuit patters have become denser in recent years.

The present invention has been made in view of the foregoing problems, and it is an object of the present invention to provide an adhesive film, capable of achieving a reduction in lubricant with lubricity imparted thereto, which is free of minute blisters on metal foil thermally laminated thereon.

### Means to Solve the Problems

As a result of diligent study of the foregoing problems, the inventors apprehended that such minute blisters on metal foil are caused by the existence of projections that are not covered with a thermoplastic polyimide, i.e., projections that are not coated with a thermoplastic polyimide. That is, the inventors apprehended that: in an area where there exist projections exposed without being covered with a thermoplastic polyimide, there exists no thermoplastic polyimide between the metal foil and the projections, so that the metal foil blisters by failing to adhere to the adhesive film. Therefore, it is considered that the method of Patent Document 2 for forming exposed projections of inorganic particles by applying and drying a dispersion liquid prepared by dispersing inorganic particles in a low-boiling organic solvent causes minute blisters on metal foil because the projections are exposed after the metal foil is laminated.

Moreover, in study of such a method for imparting lubricity as to be able to reduce the amount of lubricant while preventing projections from being exposed, the inventors found that an adhesive film obtained by coextruding (i) a solution, containing a precursor of a thermoplastic polyimide, in which a lubricant had been dispersed and (ii) a solution mainly containing a precursor of a non-thermoplastic polyimide can reduce the amount of lubricant and has a surface on which the lubricant forms projections coated with a thermoplastic polyimide. Moreover, the inventors found that such an adhesive film does not cause minute blisters on metal foil thermally laminated thereon. Thus, the inventors completed the present invention.

In order to solve the foregoing problems, an adhesive film according to the present invention is an adhesive film including: a highly heat-resistant polyimide layer which contains a non-thermoplastic polyimide and/or a precursor thereof; and thermoplastic polyimide layers, formed on both surfaces of the highly heat-resistant polyimide layer, each of which contains a thermoplastic polyimide and/or a precursor thereof, each of the thermoplastic polyimide layers having a thickness of 1.7 μm to 7.0 μm, the thermoplastic polyimide layer having a lubricant dispersed therein or the thermoplastic polyimide layer and the highly heat-resistant polyimide layer having the lubricant dispersed so as to straddle therebetween, the lubricant having a median average particle diameter of 1 μm to 10 μm, the highly heat-resistant polyimide layer having substantially no center point of the lubricant, the thermoplastic polyimide layer having a surface on which the lubricant form projections covered with a thermoplastic polyimide resin.

In the adhesive film according to the present invention, it is preferable that the surface of the thermoplastic polyimide layer have a surface roughness Rmax of less than 2 μm. Further, it is preferable that the coefficient of kinetic friction between the surfaces of the thermoplastic polyimide layers be less than 0.8.

Further, it is preferable the adhesive film according to the present invention be manufactured by a coextrusion-casting coating method.

### EFFECTS OF THE INVENTION

As described above, the adhesive film according to the present invention is arranged such that: each of the thermoplastic polyimide layers has a thickness of 1.7 μm to 7.0 μm; the thermoplastic polyimide layer has a lubricant dispersed therein or the thermoplastic polyimide layer and the highly heat-resistant polyimide layer have the lubricant dispersed so as to straddle therebetween, the lubricant having a median average particle diameter of 1 μm to 10 μm; the highly heat-resistant polyimide layer has substantially no center point of the lubricant; and the thermoplastic polyimide layer having a surface on which the lubricant form projections covered with a thermoplastic polyimide resin. This brings about an effect of providing an adhesive film, capable of achieving a reduction in lubricant with lubricity imparted thereto, which is free of minute blisters on metal foil thermally laminated thereon. Therefore, the present invention makes it possible to provide an adhesive film with lubricity imparted thereto that can be favorably used as an FPC even when a dense circuit pattern is formed.

Further, in comparison with a polyimide film, described in Patent Document 1, in which a lubricant has been entirely dispersed, the adhesive film has a high light transmittance. This makes it possible to solve such a problem, resulting from a reduction in transmittance, that an inspection of an adhesive film by light transmission for detecting defects and positioning circuits takes time and thereby reduces productivity.

### BEST MODE FOR CARRYING OUT THE INVENTION

An embodiment of the present invention will be described below in detail.

An adhesive film of the present invention is an adhesive film obtained by providing a highly heat-resistant polyimide layer and thermoplastic polyimide layers on both surfaces of the highly heat-resistant polyimide layer. The central layer has substantially no lubricant existing therein. Each of the thermoplastic polyimide layers has a lubricant, dispersed in the thermoplastic polyimide layer, which has a median average particle diameter of 1 μm to 10 μm. The lubricant existing in the thermoplastic polyimide layer is covered with a thermoplastic polyimide resin.

More specifically, an adhesive film according to the present invention is an adhesive film including: a highly heat-resistant polyimide layer which contains a non-thermoplastic polyimide and/or a precursor thereof; and thermoplastic polyimide layers, formed on both surfaces of the highly heat-resistant polyimide layer, each of which contains a thermoplastic polyimide and/or a precursor thereof, each of the thermoplastic polyimide layers having a thickness of 1.7 μm to 7.0 μm, the thermoplastic polyimide layer having a lubricant dispersed therein or the thermoplastic polyimide layer and the highly heat-resistant polyimide layer having the lubricant dispersed so as to straddle therebetween, the lubricant having a median average particle diameter of 1 μm to 10 μm, the highly heat-resistant polyimide layer having substantially no center point of the lubricant, the thermoplastic polyimide layer having a surface on which the lubricant form projections covered with a thermoplastic polyimide resin.

When the technique of Patent Document 2 for imparting lubricity is applied to an adhesive film, each of the thermoplastic polyimide layers formed as surface layers of the adhesive film may have a surface on which the lubricant forms projections that are not covered with a thermoplastic polyimide resin. Such exposed projections can cause blisters when metal foil such as copper foil is laminated on the adhesive film. Since the adhesive film according to the present invention is arranged such that the lubricant in the surface of the thermoplastic layer is covered with the thermoplastic polyimide resin, the adhesive film according to the present invention makes it possible to prevent metal foil from getting minute blisters when thermally laminated on the adhesive film. In other words, since the lubricant projections are covered with the thermoplastic polyimide resin, the thermoplastic polyimide resin exists between the projections and the metal foil when the metal foil is laminated. Therefore, the projections and the metal foil adhere to prevent the emergence of blisters. With this, in the adhesive film according to the present invention, the projections derived from the lubricant existing in the surfaces of the adhesive film imparts lubricity to the adhesive film before the adhesive film is laminated on metal foil, and is smoothed by being crushed under the pressure of lamination after the adhesive film is laminated on the metal foil. Therefore, a laminate to be obtained by laminating the adhesive film on the metal foil is free of minute blisters on the metal foil, and use of the laminate brings about an effect of forming a circuit pattern free of blisters.

Further, as with the polyimide film of Patent Document 1, an adhesive film in which a lubricant has been entirely dispersed has such a problem that the high content of lubricant exerts an unfavorable influence on the properties of the film. On the other hand, in the adhesive film according to the present invention, the highly heat-resistant polyimide layer, which occupies a large portion of the adhesive film in the thickness direction, has substantially no lubricant existing therein; therefore, such a problem can be solved. Furthermore, an adhesive film in which a lubricant has been entirely dispersed has a problem with a reduction in light transmittance. In the field where adhesive films are used, the adhesive films are often inspected by light transmission for detecting defects and positioning circuits. However, because of such a reduction in light transmittance, such an inspection takes time, thereby causing a problem with a reduction in productivity. On the other hand, in the adhesive film according to the present invention, the highly heat-resistant polyimide layer, which occupies a large portion of the adhesive film in the thickness direction, has substantially no lubricant existing therein; therefore, light transmittance can be ensured. This brings about an effect of preventing a reduction in productivity even when the adhesive film is inspected by light transmission for detecting defects and positioning circuits.

Furthermore, in the adhesive film according to the present invention, the thermoplastic polyimide layer having a lubricant mainly dispersed therein and the highly heat-resistant polyimide layer having substantially no center point of the lubricant are both polyimide layers. This makes it possible to obtain an adhesive film uniform in quality of each layer. This brings about an effect of improving adhesion between the layers and preventing the layers from being curled due to a difference in coefficient of thermal expansion.

In the following, (I) an adhesive according to the present invention and (II) a method for manufacturing an adhesive film according to the present invention will be described in the order named.

(I) Adhesive Film

(I-1) Arrangement of an Adhesive Film

An adhesive film according to the present invention is an adhesive film, including a highly heat-resistant polyimide layer and thermoplastic polyimide layers formed on both surfaces of the highly heat-resistant polyimide film, to which lubricity has been imparted by dispersing a lubricant in each of the thermoplastic polyimide layers or between the thermoplastic polyimide layer and the highly heat-resistant polyimide layer. The lubricant forms projections on a surface of each of the thermoplastic polyimide layers formed as surface layers of the adhesive film.

The adhesive film according to the present invention includes a highly heat-resistant polyimide layer and thermoplastic polyimide layers formed on both surfaces of the highly heat-resistant polyimide film. The highly heat-resistant polyimide layer contains a non-thermoplastic polyimide and/or a precursor thereof. The term “non-thermoplastic polyimide” generally means a polyimide that does not become soft or adhesive even when heated. In the present invention, the term “non-thermoplastic polyimide” means a polyimide having a glass-transition temperature (Tg) of not less than 280° C. or a polyimide having no glass-transition temperature (Tg). It should be noted that Tg can be found based on the value of an inflection point of a storage modulus of elasticity measured by a dynamic viscoelasticity measuring apparatus (DMA). On the other hand, each of the thermoplastic polyimide layers contains a thermoplastic polyimide and/or a precursor thereof. The term “thermoplastic polyimide” generally means a polyimide that becomes soft and adhesive when heated. In the present invention, the term “thermoplastic polyimide” means a polyimide having a glass-transition temperature (Tg) of less than 280° C.

Each of the thermoplastic polyimide layers has a thickness of 1.7 μm to 7.0 μm. Further, the thickness of the highly heat-resistant polyimide layer is not particularly limited. However, the thickness of the highly heat-resistant polyimide layer is normally greater than the thickness of the thermoplastic layer. It is preferable that the highly heat-resistant polyimide layer have a thickness of 7 μm to 30 μm.

In the adhesive film according to the present invention, the lubricant is dispersed in each of the thermoplastic polyimide layers or dispersed so as to straddle between the thermoplastic polyimide layer and the highly heat-resistant polyimide layer. Since the lubricant is thus dispersed in the vicinity of the thermoplastic polyimide layer close to a surface of the adhesive film, the lubricant can form projections on a surface of the thermoplastic polyimide layer, i.e., on a surface of the adhesive film. This makes it possible to suitably impart lubricity to the adhesive film.

It should be noted here that the lubricant only needs to be dispersed in each of the thermoplastic polyimide layers or dispersed so as to straddle between the thermoplastic polyimide layer and the highly heat-resistant polyimide layer. That is, the lubricant may be dispersed so as to be entirely covered with the thermoplastic polyimide layer, or may be dispersed so as to straddle between the thermoplastic polyimide layer and the highly heat-resistant polyimide layer.

The particle diameter or size of the lubricant in the thickness direction of the adhesive film may be less than the thickness of the thermoplastic polyimide layer, or may be greater than the thickness of the thermoplastic polyimide layer. It should be noted that in cases where the particle diameter or size of the lubricant in the thickness direction of the adhesive film may be greater than the thickness of the thermoplastic polyimide layer, the lubricant is dispersed so as to straddle between the thermoplastic polyimide layer and the highly heat-resistant polyimide layer.

Further, in order to suitably impart lubricity, it is preferable that the lubricant be uniformly dispersed.

The lubricant is not particularly limited as long as it is in the form of particles inactive against all chemical substances that make contact therewith in process of manufacture of the adhesive film and capable of imparting lubricity to the adhesive film, and may be any one of the so-called inorganic fillers. Preferred examples of the lubricant include silica, titanium oxide, alumina, silicon nitride, boron nitride, calcium carbonate, calcium hydrogen phosphate, calcium phosphate, and mica.

Further, the lubricant is in the form of particles, and it is preferable that each of the particles have a spherical shape. However, each of the particles may have another shape such as a rod shape, an elliptical shape, a square shape, a plate shape, or a short-fiber shape.

As for the size of the lubricant, it is preferable that the lubricant have a median average particle diameter of 1 μm to 10 μm. The term “median average particle diameter” here means the median value of a series of measurements arranged in order of magnitude (in cases where the number of particles is an odd number) or the arithmetic average of two center values of the series (in cases where the number of particles is an even number), and can be measured by a light-scattering particle sizing device. In the present invention, the term “median average particle diameter” means a value measured with use of a Partica LA-300 manufactured by Horiba, Ltd.

As for the size of the lubricant, it is preferable that the lubricant have a median average particle diameter of 1 μm to 10 μm. However, it is more preferable that the lubricant have a median average particle diameter of 1 μm to 5 μm, or still more preferably 1 μm to 3 μm.

If the median average particle diameter of the lubricant exceeds 10 μm, the lubricant may not be covered with the thermoplastic polyimide resin, with the possible result that metal foil gets minute blisters on it after being laminated. On the other hand, if the median average particle diameter of the lubricant falls short of 1 μm, the lubricant may undesirably fail to exhibit sufficient lubricity.

Further, it is preferable that the lubricant be added in an amount of 0.01 to 100 parts by weight, more preferably 0.01 to 90 parts by weight, or still more preferably 0.02 to 80 parts by weight, with respect to 100 parts by weight of the thermoplastic polyimide layer. If the amount of the lubricant to be added falls short of this range, the lubricant has difficulty in bringing about a remarkable improvement effect. If the amount of the lubricant to be added exceeds this range, there is a possibility of greatly impairing the mechanical properties of the film.

Further, in the adhesive film according to the present invention, the highly heat-resistant polyimide layer has substantially no lubricant existing therein. The phrase “has substantially no lubricant existing therein” here means that although there may exist a lubricant dispersed so as to straddle between the thermoplastic polyimide layer and the highly heat-resistant polyimide layer, there exists substantially no lubricant whose center point exists in the highly heat-resistant polyimide layer. It should be noted that the phrase “has substantially no lubricant existing therein” here means that assuming the whole lubricant existing in the adhesive film is 100 parts by weight, the lubricant whose center point exists in the highly heat-resistant polyimide layer is 0 to 10 parts by weight, more preferably 0 to 5 parts by weight, or still more preferably 0 to 2 parts by weight. Further, the phrase “has substantially no lubricant existing therein” may also mean that assuming that the particle count of the whole lubricant existing in the adhesive film is 100%, the particle count of the lubricant whose center point exists in the highly heat-resistant polyimide layer is 0% to 10%, more preferably 0% to 5%, or still more preferably 0% to 2%. The term “center point” of the lubricant here means the center of the long-axis diameter of the lubricant in the thickness direction of the adhesive film, i.e., the center of the maximum dimensions of the lubricant in the thickness direction of the adhesive film.

It should be noted here that in order to confirm that there exists substantially no lubricant whose center point exists in the highly heat-resistant polyimide layer, it is possible to use, for example, a method for microscopically observing a cross-section of the adhesive film.

In comparison with the case of an adhesive film in which a lubricant has been entirely dispersed, the highly heat-resistant polyimide layer having substantially no lubricant existing therein make it possible to reduce the total amount of lubricant. This makes it possible to inhibit the properties of an adhesive film from deteriorating due to a large amount of lubricant. In addition, in comparison with the case of an adhesive film in which a lubricant has been entirely dispersed, the highly heat-resistant polyimide layer having substantially no lubricant existing therein has a high light transmittance. This makes it possible to solve such a problem, resulting from a reduction in transmittance, that an inspection of an adhesive film by light transmission for detecting defects and positioning circuits takes time and thereby reduces productivity.

Further, in the adhesive film according to the present invention, the thermoplastic polyimide layer has a surface on which the lubricant forms projections, thereby imparting lubricity. Moreover, the projections are covered with a thermoplastic polyimide resin. The phrase “projections are covered with a thermoplastic polyimide resin” here means that the projections, which are those portions of the lubricant which project from the surface of the thermoplastic polyimide layer, only need to be coated with a thermoplastic polyimide resin without being exposed. Further, the higher the proportion of projections coated with a thermoplastic polyimide resin, the lower the proportion of blisters that emerge when metal foil such as copper foil is laminated on the adhesive film. Therefore, it is preferable that the proportion of projections coated with a thermoplastic polyimide resin to total projections be 80%, more preferably 90%, or still more preferably 95%, in terms of the number of projections.

It should be noted that in order to confirm that the protrusions formed by the lubricant are covered with a thermoplastic polyimide resin, it is possible to observe a surface of the adhesive film according to the present invention with an optical microscope or an electron microscope such as an SEM or a TEM.

Further, it is preferable that each of the projections have a height of 0.01 μm to 10 μm. If the height of the protrusion is less than 0.01 μm, the lubricant undesirably fails to impart sufficient lubricity. On the other hand, if the height of the protrusion is greater than 10 μm, the metal foil may undesirably get minute blisters on it when laminated. Further, it is preferably that the frequency of projections fall within a range of 1×10² pcs/mm² to 1×10¹⁰ pcs/mm². If the frequency of projections is less than 1×10² pcs/mm², the lubricant undesirably fails to impart sufficient lubricity. If the frequency of projections is greater than 1×10¹⁰ pcs/mm², the metal foil may undesirably get minute blisters on it when laminated.

It is preferable that each of the thermoplastic polyimide layers (hereinafter referred to sometimes as “adhesive layers”) of the adhesive film according to the present invention have a surface roughness Rmax of not less than 0.05 μm to less than 2 μm. If Rmax is not less than 2 μm, the metal foil may get minute blisters on it after being laminated. If Rmax is less than 0.05 μm, the lubricant fails to exert its effect, with the possible result that the adhesive film gets creases in it when manufactured.

Further, it is preferable that the surfaces of the adhesive layers of the adhesive film according to the present invention have a coefficient of kinetic friction of less than 0.8. In cases where the coefficient of kinetic friction between the surfaces of the adhesive layers exceeds the above range, the adhesive film may get creases in it when manufactured.

In the present invention, the term “surface roughness Rmax” means a maximum surface roughness measured at a cutoff value of 0.25 mm with use of a surface roughness meter Surftest SJ-301 of Mitutoyo Corporation's manufacture in accordance with the “surface roughness” pursuant to JIS B-0601.

Further, in the present invention, the coefficient of kinetic friction is obtained by the following method pursuant to JIS K7125. That is, the coefficient of kinetic friction means a value obtained according to JIS K7125 except that instead of joining, onto a contact surface of a slide piece, a piece of felt prescribed in JIS L3201, test pieces cut out from the adhesive film so as to have the same amount of space are lubricously fixed so that the adhesive layers face each other.

(I-2) High Heat-resistant Polyimide Layer

In the adhesive film according to the present invention, the highly heat-resistant polyimide layer is not particularly limited in terms of the amount of a non-thermoplastic polyimide and/or a precursor thereof that are/is contained in the layer, the molecular structure, and the thickness, as long as it contains the non-thermoplastic polyimide and/or the precursor thereof at not less than 90 wt %. The non-thermoplastic polyimide for use in the highly heat-resistant polyimide layer is manufactured by using polyamic acid as a precursor. Further, in the adhesive film according to the present invention, the non-thermoplastic polyimide of the highly heat-resistant polyimide layer may be completely imidized, or may contain a precursor yet to be imidized, i.e., polyamic acid.

The polyamic acid can be manufactured by any publicly-known method. Usually, the polyamic acid can be manufactured by dissolving substantially equimolar amounts of aromatic tetracarboxylic acid dianhydride and aromatic diamine in an organic solvent and by stirring the resulting solution under controlled temperature conditions until completion of polymerization of the acid dianhydride and the diamine. Usually, such a polyamic acid solution is obtained in a concentration of 5 wt % to 35 wt %, or preferably 10 wt % to 30 wt %. In cases where the concentration falls within this range, an appropriate molecular weight and an appropriate solution viscosity are obtained.

The polymerization method can be any one of the publicly-known methods or a combination of those methods. The feature of the method for forming the polyamic acid by polymerization lies in the order in which the monomers are added, and the properties of the resulting polyimide can be controlled by controlling the order in which the monomers are added. Therefore, in the present invention, the polyamic acid can be formed by polymerization by any method for adding a monomer. Typical examples of the polymerization method include the following methods.

That is, a first method is a method for performing polymerization by dissolving aromatic diamine in an organic polar solvent and by allowing the aromatic diamine to react with a substantially equimolar amount of aromatic tetracarboxylic acid dianhydride.

Further, a second method is a method for, by allowing aromatic tetracarboxylic acid dianhydride and an excessively smaller molar quantity of aromatic diamine compound to react with each other in an organic polar solvent, obtaining a prepolymer having acid anhydride groups at both terminals thereof; and then performing polymerization with use of the aromatic diamine compound so that the aromatic tetracarboxylic acid dianhydride and the aromatic diamine compound are used in substantially equimolar amounts in the entire process.

Further, a third method is a method for, by allowing aromatic tetracarboxylic acid dianhydride and an excessive molar quantity of aromatic diamine compound to react with each other in an organic polar solvent, obtaining a prepolymer having amino groups at both terminals thereof; and then performing polymerization with use of the aromatic tetracarboxylic acid dianhydride after addition of an aromatic diamine compound so that the aromatic tetracarboxylic acid dianhydride and the aromatic diamine compound are used in substantially equimolar amounts in the entire process.

Further, a fourth method is a method for, after dissolving and/or dispersing aromatic tetracarboxylic acid dianhydride in an organic polar solvent, performing polymerization with use of an aromatic diamine compound so that the aromatic tetracarboxylic acid dianhydride and the aromatic diamine compound are in substantially equimolar amounts.

Further, a fifth method is a method for performing polymerization by allowing a mixture of substantially equimolar amounts of aromatic tetracarboxylic acid dianhydride and aromatic diamine to react in an organic polar solvent.

These methods may be used alone, or may be partially combined for use. The non-thermoplastic polyimide for use in the present invention may be any polyamic acid obtained with use of the polymerization method(s), and the polymerization method(s) is/are not particularly limited.

In order to obtain the non-thermoplastic polyimide for use in the present invention, it is preferable to use a polymerization method for obtaining a precursor (hereinafter referred to sometimes as “prepolymer” by using a diamine component having a rigid structure to be described later. Use of the diamine component having a rigid structure tends to result in a polyimide film having a high glass-transition temperature, a high modulus of elasticity, and a small coefficient of hygroscopic expansion.

It is preferable that the molar ratio of rigidly-structured aromatic diamine to aromatic tetracarboxylic acid dianhydride in the preparation of the prepolymer fall within a range of 100:70 to 100:99 or 70:100 to 99:100, or more preferably 100:75 to 100:90 or 75:100 to 90:100. When the ratio falls short of the range, it is hard to bring about improvement in modulus of elasticity and in coefficient of hygroscopic expansion. Above the range, there may be undesirably an excessive reduction in coefficient of linear expansion or an excessive reduction in tensile elongation.

The following explains the materials for use in manufacture of the polyamic acid for obtaining the non-thermoplastic polyimide for use in the present invention. Examples of an aromatic tetracarboxylic acid dianhydride that can be suitably used as such a material include pyromellitic acid dianhydride, 2,3,6,7-naphthalene tetracarboxylic acid dianhydride, 3,3′,4,4′-biphenyl tetracarboxylic acid dianhydride, 1,2,5,6-naphthalene tetracarboxylic acid dianhydride, 2,3,3′,4′-biphenyl tetracarboxylic acid dianhydride, 3,3′,4,4′-benzophenone tetracarboxylic acid dianhydride, 4,4′-oxyphthalic acid dianhydride, 2,2-bis(3,4-dicarboxyphenyl)propane dianhydride, 3,4,9,10-perylene tetracarboxylic acid dianhydride, bis(3,4-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)ethane dianhydride, oxydiphthalic acid dianhydride, bis(3,4-dicarboxyphenyl)sulfonic dianhydride, p-phenylene bis(trimellitic acid monoester anhydride), ethylene bis(trimellitic acid monoester anhydride), bisphenol A bis(trimellitic acid monoester anhydride), and compounds similar thereto. These aromatic tetracarboxylic acid dianhydrides may be used alone, or may be mixed at a given ratio.

Among these aromatic tetracarboxylic acid dianhydrides, pyromellitic acid dianhydride, 3,3′,4,4′-benzophenone tetracarboxylic acid dianhydride, 4,4′-oxyphthalic acid dianhydride, 3,3′,4,4′-biphenyl tetracarboxylic acid dianhydride, or a combination of two or more of them is suitably used.

Further, among these aromatic tetracarboxylic acid dianhydrides, 3,3′,4,4′-benzophenone tetracarboxylic acid dianhydride, 4,4′-oxyphthalic acid dianhydride, 3,3′,4,4′-biphenyl tetracarboxylic acid dianhydride, or a combination of two or more of them is preferably used in an amount of not more than 60 mol %, more preferably not more than 55 mol %, or still more preferably not more than 50 mol %, with respect to the entire aromatic tetracarboxylic acid dianhydrides. When the amount exceeds the range, the polyimide film may undesirably have too low a glass-transition temperature and too low a storage modulus of elasticity at the time of heating to form a film.

Further, in cases where pyromellitic acid dianhydride is used, the pyromellitic acid dianhydride is preferably used in an amount of 40 mol % to 100 mol %, more preferably 45 mol % to 100 mol %, or still more preferably 50 mol % to 100 mol %, with respect to the entire aromatic tetracarboxylic acid dianhydrides. Use of the pyromellitic acid dianhydride within this range makes it easy to keep the glass-transition temperature of the polyimide film within an appropriate range and to keep the storage modulus of elasticity of the polyimide film at the time of heating within an range appropriate for use and film formation.

Appropriate examples of an aromatic diamine that can be used for manufacturing the polyamic acid for obtaining the non-thermoplastic polyimide for use in the present invention include 4,4′-diaminodiphenylpropane, 4,4′-diaminodiphenylmethane, benzidine, 3,3′-dichlorobenzidine, 3,3′-dimethylbenzidine, 2,2′-dimethylbenzidine, 3,3′-dimethoxybenzidine, 2,2′-dimethoxybenzidine, 4,4′-diaminodiphenylsulfide, 3,3′-diaminodiphenylsulfone, 4,4′-diaminodiphenylsulfone, 4,4′-oxydianiline, 3,3′-oxydianiline, 3,4′-oxydianiline, 1,5-diaminonaphthalene, 4,4′-diaminodiphenyldiethylsilane, 4,4′-diaminodiphenylsilane, 4,4′-diaminodiphenylethylphosphine oxide, 4,4′-diaminodiphenyl N-methylamine, 4,4′-diaminodiphenyl N-phenylamine, 1,4-diaminobenzene (p-phenylenediamine), 1,3-diaminobenzene, 1,2-diaminobenzene, bis{4-(4-aminophenoxy)phenyl}sulfone, bis{4-(4-aminophenoxy)phenyl}propane, bis{4-(3-aminophenoxy)phenyl}sulfone, 4,4′-bis(4-aminophenoxy)biphenyl, 4,4′-bis(3-aminophenoxy)biphenyl, 1,3-bis(3-aminophenoxy)benzene, 1,3-bis(4-aminophenoxy)benzene, 1,3-bis(4-aminophenoxy)benzene, 1,3-bis(3-aminophenoxy)benzene, 3,3′-diaminobenzophenone, 4,4′-diaminobenzophenoe, and compounds similar thereto. These aromatic diamines may be used alone, or may be mixed at a given ratio.

As the aromatic diamine component, a combination of a diamine having a rigid structure and an amine having a flexible structure can be used. In that case, it is preferable that the molar ratio (of the rigidly-structured diamine to the flexibly-structured amine) fall within a range of 80/20 to 20/80, more preferably 70/30 to 30/70, or still more preferably 60/40 to 30/70. When the rigidly-structured diamine exceeds the range, there tends to be a reduction in tensile elongation of a film to be obtained. Further, below the range, the glass-transition temperature and the storage modulus of elasticity at the time of heating undesirably become too low to form a film.

The rigidly-structured diamine only needs to be a diamine, structured such that two amino-group nitrogen atoms and a carbon atom to which the two amino-group nitrogen atoms are bonding, whose principal chain does not contain a flexible-structure imparting group such as an ether group, a methylene group, a propargylic group, a hexafluoropropargylic group, a carbonyl group, a sulfonic group, or a sulfide group. Preferably, the diamine having a rigid structure is represented below by General Formula (1):

H₂N—R²—NH₂ General Formula (1)

(where R² is a group selected from the group consisting of bivalent aromatic groups represented below by Group of General Formulas (1):

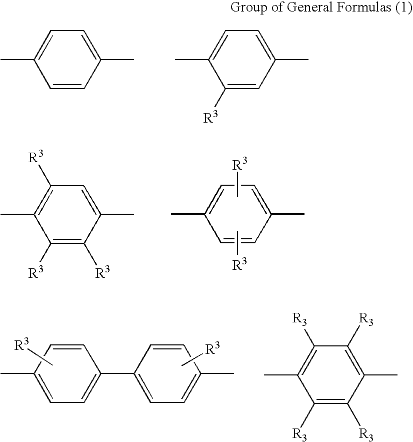

where R³s are each independently a group selected from the group consisting of H—, CH₃—, —OH, —CF₃, —SO₄, —COOH, —CO—NH₂, Cl—, Br—, F—, and CH₃O—).

Further, the flexibly-structured diamine only needs to be a diamine whose principal chain contains a flexible-structure imparting group such as an ether group, a methylene group, a propargylic group, a hexafluoropropargylic group, a carbonyl group, a sulfonic group, or a sulfide group. Preferably, the flexibly-structured diamine is represented below by

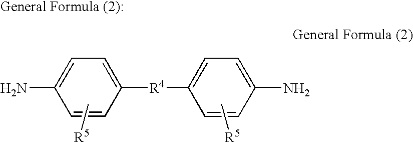

(where R⁴ is a group selected from the group consisting of bivalent organic groups represented below by Group of General Formulas (2)

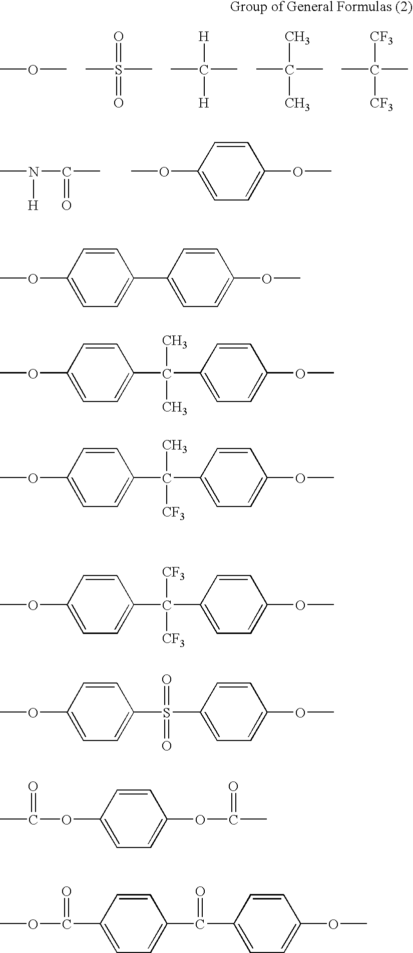

and R⁵s are each independently is H—, CH₃—, —OH, —CF₃, —SO₄, —COOH, —CO—NH₂, Cl—, Br—, F—, and CH₃O—).

The non-thermoplastic polyimide contained in the highly heat-resistant polyimide layer for use in the present invention and the polyamic acid serving as the precursor thereof can be obtained with use of an appropriate type of aromatic tetracarboxylic acid dianhydride, an appropriate type of aromatic diamine, and an appropriate blending ratio so as to have desired properties within the aforementioned ranges.

The polyamic acid can be preferably synthesized with use of any solvent in which the polyamic acid is dissolved. Suitably usable examples of such a solvent include amide solvents such as N,N-dimethylformamide, N,N-dimethylacetoamide, and N-methyl-2-pyrrolidone. Among them, N,N-dimethylformamide and N,N-dimethylacetoamide can be suitably used in particular.

From the point of view of reducing an unfavorable influence of a large amount of lubricant on the adhesive film and improving light transmittance, it is preferable that the highly heat-resistant polyimide layer of the adhesive film of the present invention have substantially no lubricant existing therein. From such a point of view, it is preferable that an organic or inorganic powder generally called a filler should not be actively introduced into the highly heat-resistant polyimide layer. However, various fillers may be added for the purpose of controlling other properties such as slidability, thermal conductivity, electrical conductivity, corona resistance, and loop stiffness.

A solution containing the non-thermoplastic polyimide precursor thus obtained is referred to as a solution containing a highly heat-resistant polyimide precursor.

(I-3) Thermoplastic Polyimide Layer

In the adhesive film according to the present invention, each of the thermoplastic polyimide layers is not particularly limited in terms of the amount of a thermoplastic polyimide resin and/or a precursor thereof that are/is contained in the layer, the molecular structure, and the thickness, as long as it expresses properties such as a significant strength of adhesion to metal foil such as copper foil serving as a conductor and an optimum coefficient of linear expansion. However, in order to express desired properties such as a significant strength of adhesion and an optimum coefficient of linear expansion, it is preferable that the thermoplastic polyimide layer contain the thermoplastic polyimide and/or the precursor thereof at not less than 50 wt %.

Suitably usable examples of the thermoplastic polyimide include thermoplastic polyimide, thermoplastic polyamide imide, thermoplastic polyether imide, and thermoplastic polyester imide. Among them, thermoplastic polyester imide can be suitably used from the point of view of low hygroscopic properties.

The thermoplastic polyimide contained in the thermoplastic polyimide layer is obtained through a reaction of conversion from polyamic acid serving as a precursor thereof. Further, in the adhesive film according to the present invention, the thermoplastic polyimide of the thermoplastic polyimide layer may be completely imidized, or may contain a precursor yet to be imidized, i.e., polyamic acid. The polyamic acid can be manufactured by any publicly-known method as with the precursor of the highly heat-resistant polyimide layer.

Further, from the point of view of obtaining an adhesive film that can be laminated on metal foil by an existing apparatus and does not impair the heat resistance of a metal-clad laminate (hereinafter referred to sometimes as “flexible metal-clad laminate”) to be obtained, it is preferable that the glass-transition temperature (Tg) of the thermoplastic polyimide fall within a range of not less than 150° C. to less than 280° C. It should be noted that Tg can be found based on the value of an inflection point of a storage modulus of elasticity measured by a dynamic viscoelasticity measuring apparatus (DMA).

The polyamic acid, i.e., the precursor of the thermoplastic polyimide is not particularly limited, and can be any publicly-known polyamic acid. As for the manufacture of a polyamic acid solution, it is possible to use just the same materials and manufacturing conditions as described above.

The properties of the thermoplastic polyimide can be adjusted by various combinations of materials to be used. Usually, an increase in ratio of rigidly-structured diamine used causes an increase in glass-transition temperature and/or an increase in storage modulus of elasticity at the time of heating, thereby undesirably causing a reduction in adhesiveness and processability. The ratio of rigidly-structured diamine is preferably not more than 40 mol %, more preferably not more than 30 mol %, or still more preferably not more than 20 mol %, with respect to total diamine to be used.

Specific examples of a preferable thermoplastic polyimide resin include a product of a reaction of polymerization of acid dianhydride containing biphenyl tetracarboxylic acid dianhydrides and diamine having an aminophenoxy group.

The thermoplastic polyimide layer of the adhesive film according to the present invention has a lubricant so dispersed therein as to impart lubricity to the adhesive film. In addition to the lubricant, various fillers may be added for the purpose of controlling other properties such as slidability, thermal conductivity, electrical conductivity, corona resistance, and loop stiffness.

(II) Manufacture of an Adhesive Film

A method for manufacturing an adhesive film of the present invention is not particularly limited as long as it is a method capable of manufacturing such an adhesive film as described above. A preferred example of such a method is a manufacturing method including the step of forming a plurality of liquid films on a support with use of two or more types of solutions each containing a polyimide and/or a precursor thereof and then drying and imidizing the liquid films. Examples of the solution containing a polyimide and/or the two or more types of solution containing a polyimide precursor include a solution containing a non-thermoplastic polyimide and/or a precursor thereof and a solution containing a thermoplastic polyimide and/or a precursor thereof. Further, in so doing, a lubricant is added to the solution, containing a thermoplastic polyimide and/or a precursor thereof, from which a thermoplastic polyimide layer is formed. Usable examples of the method for forming a plurality of liquid films on a support include conventionally known methods such as a method involving the use of a multilayer die, a method involving the use of a slide die, a method involving the use of an array of single-layer dies, and a method involving the use of a combination of a single-layer die and spray coating or gravure coating. However, the coextrusion-casting coating method involving the use of a multilayer die is preferable in particular in consideration of capability of manufacturing an adhesive film in which projections formed by a lubricant are suitably covered with a thermoplastic polyimide resin, productivity, maintainability, and the like. In the following, the coextrusion-casting coating method involving the use of a multilayer die will be described by way of example.

First, as described above in (1-2), a solution, containing a precursor of a non-thermoplastic polyimide, from which a highly heat-resistant polyimide layer is formed is prepared.

Further, as described above in (1-3), a solution is prepared by adding a lubricant to the solution, containing a precursor of a thermoplastic polyimide, from which a thermoplastic polyimide layer is formed. There is no limit on how the lubricant is added. However, typical examples of how the lubricant is added include the following methods.

That is, a first method is a method for adding a lubricant to a polymerization reaction liquid before or during polymerization formation of polyamic acid serving as a precursor of a thermoplastic polyimide.

Further, a second method is a method for kneading a lubricant with use of a three-roll mill or the like after completion of polymerization formation of polyamic acid serving as a precursor of a thermoplastic polyimide.

Further, a third method is a method for preparing a dispersion liquid containing a lubricant, and for mixing the dispersion liquid into a polyamic acid organic solvent solution serving as a precursor of a thermoplastic polyimide.

Further, a fourth method is a method for, after completion of polymerization formation of polyamic acid serving as a precursor of a thermoplastic polyimide, preparing a master batch by kneading a lubricant with use of a three-roll mill or the like, and for, immediately before film formation, mixing the master batch with a polyamic acid solution serving as a precursor of a thermoplastic polyimide.

It is possible to use any one of the above methods. However, the method for mixing a lubricant-containing dispersion liquid into a polyamic acid organic solvent solution or, in particular, the method for mixing a lubricant-containing dispersion liquid into a polyamic acid organic solvent solution immediately before film formation is preferable because it minimizes contamination of a manufacturing line by the filler. In the case of preparation of a dispersion liquid containing a lubricant, it is preferable to use the same solvent as the solvent used in forming the polyamic acid by polymerization. Further, in order to satisfactorily disperse the lubricant in a stable dispersion state, it is possible to use a dispersing agent, a thickening agent, and the like to such an extent as not to affect the properties of the film.

Then, the solution, containing a precursor of a non-thermoplastic polyimide, from which a highly heat-resistant polyimide layer is formed and the lubricant-dispersed solution, containing a precursor of a thermoplastic polyimide, from which a thermoplastic layer is formed are fed into a multilayer die having three or more layers, and then extruded from outlets of the multilayer die as a plurality of liquid layers. Then, the plurality of liquid layers thus extruded from the multilayer die are flow-cast onto a flat and smooth support. By volatilizing at least part of the solvent from the plurality of liquid layers thus flow-cast onto the support, a self-supporting multilayer film is obtained. Furthermore, the multilayer film is peeled away from the support, and then finally treated sufficiently at a high temperature (of 250° C. to 600° C.). This makes it possible to manufacture the intended adhesive film by substantially removing the solvent and proceeding with the imidization. Further, for the purpose of improving the melting fluidity of an adhesive layer, the imidization ratio may be intentionally lowered and/or the solvent may be intentionally left.

In consideration of uses for an adhesive film to be finally obtained, it is preferable that the support have as flat and smooth a surface as possible. Furthermore, in consideration of productivity, it is preferable that the support be an endless belt or a drum.

There is no special limit on how to volatilize the solvent from (i) the solution, containing a precursor of a non-thermoplastic polyimide, from which a highly heat-resistant polyimide layer is formed and (ii) the solution containing a precursor of a thermoplastic polyimide, from which a thermoplastic polyimide layer is formed, the solutions having been extruded from a multilayer die having three or more layers (such a multilayer die being hereinafter referred to sometimes as “extrusion die having three or more layers”). However, the easiest way is through heating and/or blowing. If the heating is performed at an excessively high temperature, the solvent is suddenly volatilized, thereby leaving traces that form minute defects in an adhesive film to be finally obtained. Therefore, it is preferable that the heating be performed at a temperature of less than 50° C. plus the boiling point of the solvent used.

As for the imidization time, it is only necessary to take sufficient time for the film to be substantially completely imidized and dried. Although not uniquely defined, the imidization time is generally set appropriately so as to fall within a range of approximately 1 second to 600 seconds.

It is preferable that the tension to be applied during imidization fall within a range of 1 kg/m to 15 kg/m, or more preferably 5 kg/m to 10 kg/m. When the tension falls short of the range, the film sags or meanders when conveyed, and may therefore crease when wound or may not be uniformly wound, for example. On the other hand, when the tension exceeds the range, the film is heated at a high temperature under high tension. This may cause deterioration in dimensional stability of a metal-clad laminate to be manufactured with use of the adhesive film according to the present invention.

The extrusion die having three or more layers may be of various structures, but usable examples thereof include a die for preparing a plurality of layers. Further, it is possible to suitably use a die of any conventionally known structure as the extrusion die, but especially suitably usable examples of thereof include a feed-block die and a multimanifold die.

In the case of use of the coextrusion-casting coating method, projections formed by a lubricant so as to exist on a surface of an adhesive film to be obtained are coated with a thermoplastic polyimide. The possible reason for this is as follows: Because each of the solutions coextruded to form a highly heat-resistant polyimide layer and thermoplastic polyimide layers on both surfaces of the highly heat-resistant polyimide layer has a high viscosity, the lubricant can freely move from one layer to another. That is, when the projections formed by the lubricant are almost exposed, the lubricant is pushed toward the highly heat-resistant polyimide layer serving as a central layer and is unlikely to eliminate the thermoplastic polyimide precursor coating the lubricant.

Generally, a polyimide is obtained through a dehydration reaction of conversion from a polyimide precursor, i.e., polyamic acid. There are two widely known methods for producing the reaction of shift conversion: a thermal curing method for producing the reaction only by heat; and a chemical curing method for producing the reaction with use of a chemical curing agent containing a chemical dehydrating agent and a catalyst. However, in consideration of the efficiency of manufacture, the chemical curing method is preferable.

As the chemical dehydrating agent according to the present invention, a dehydration ring closure agent for various types of polyamic acid can be used. Preferably usable examples of the chemical dehydrating agent include aliphatic acid anhydride, aromatic acid anhydride, N,N′-dialkylcarbodiimide, lower aliphatic halide, halogenated lower aliphatic acid anhydride, arylsulfonic acid dihalide, thionyl halide, and a mixture of two or more of them. Among them, aliphatic acid anhydride and aromatic acid anhydride exert a favorable effect. Further, the catalyst broadly means a component having an effect of enhancing the dehydration ring closure action of the chemical dehydrating agent with respect to the polyamic acid. Usable examples of the catalyst include aliphatic tertiary amines, aromatic tertiary amines, and heterocyclic tertiary amines. Among them, a nitrogen-containing heterocyclic compound such as imidazole, benzimidazole, isoquinoline, quinoline, or β-picoline is preferable in particular. Furthermore, it is possible to appropriately choose to introduce an organic polar solvent into a solution composed of the chemical dehydrating agent and the catalyst.

It is preferable that the chemical dehydrating agent be used in an amount of 0.5 mol to 5 mol, or more preferably 0.7 mol to 4.0 mol, with respect to 1 mol of amic acid unit contained in the polyamic acid contained in the solution containing the chemical dehydrating agent and the catalyst. It is preferable that the imidization catalyst be added in an amount of 0.05 mol to 3 mol, or more preferably 0.2 mol to 2 mol, with respect to 1 mol of amic acid unit contained in the polyamic acid contained in the solution containing the chemical dehydrating agent and the catalyst. If the chemical dehydrating agent and the catalyst fall short of those ranges, there may be breakage in process of calcination and deterioration in mechanical strength due to insufficient chemical imidization. Further, if the chemical dehydrating agent and the catalyst exceed those ranges, there may be too rapid progress in imidization. Such rapid progress in imidization makes it difficult to be cast into the form of a film. Therefore, it is not preferable that the chemical dehydrating agent and the catalyst exceed those ranges.

According to a preferred embodiment, metal foil is laminated so as to adhere to at least one surface of an adhesive film to be finally obtained. Therefore, in consideration of the dimensional stability of the adhesive film having metal foil adhering to at least one surface thereof, i.e., the adhesive film processed into a flexible metal-clad laminate, it is preferable that the coefficient of thermal expansion of the adhesive film at 100° C. to 200° C. be controlled so as to fall within a range of 4 ppm/° C. to 30 ppm/° C., more preferably 6 ppm/° C. to 25 ppm/° C., or still more preferably 8 ppm/° C. to 22 ppm/° C.

In cases where the coefficient of thermal expansion of the adhesive film exceeds the range, the coefficient of thermal expansion of the adhesive film is far greater than the coefficient of thermal expansion of the metal foil. This makes a big difference in thermal behavior between the adhesive film and the metal foil at the time of lamination with a possible increase in dimensional change of a flexible metal-clad laminate to be obtained. In cases where the coefficient of thermal expansion of the adhesive film falls short of the range, the coefficient of thermal expansion of the adhesive film is far less than the coefficient of thermal expansion of the metal foil. This also makes a big difference in thermal behavior with a possible increase in dimensional change of a flexible metal-clad laminate to be obtained.

The coefficient of thermal expansion of the adhesive film is controlled, for example, by a method for adjusting drying conditions and calcination conditions, by a method for adjusting the amount of a chemical curing agent, or by a method for adjusting the thickness ratio between a highly heat-resistant polyimide layer and a thermoplastic polyimide layer. It is possible to use any one of the methods or a combination of two or more of them.

The coefficient of thermal expansion of the adhesive film can be measured, for example, with use of a TMA120C manufactured by Seiko Instruments Inc. The coefficient of thermal expansion of the adhesive film is a value obtained by once increasing the temperature of a sample with the dimensions 3 mm×10 mm under a load of 3 g from 10° C. to 400° C. at 10° C./min, cooling down the sample to 10° C. then, increasing the temperature of the sample again at 10° C./min, and calculating the average from the coefficient of thermal expansion from 100° C. to 200° C. at the time of the second increase in temperature.

The total thickness of the adhesive film is not particularly limited, either, but can be appropriately adjusted as usage. For example, in cases where the adhesive film is used as a base material for a flexible printed-circuit board, an appropriate total thickness falls within a range of 10 μm to 40 μm.

### EXAMPLES

The present invention will be fully described below by way of Examples. However, the present invention is not limited to these Examples. It should be noted that the properties of Examples of Synthesis, Examples, and Comparative Examples were evaluated in the following manner.

<Surface Roughness Rmax of an Adhesive Layer>

The maximum surface roughness Rmax was measured at a cutoff value of 0.25 mm with use of a surface roughness meter Surftest SJ-301 of Mitutoyo Corporation's manufacture in accordance with the “surface roughness” pursuant to JIS B-0601.

<Coefficient of Kinetic Friction>

Further, according to the present invention, the coefficient of kinetic friction is obtained by the following method pursuant to JIS K7125. That is, the coefficient of kinetic friction means a value obtained according to JIS K7125 except that instead of joining, onto a contact surface of a slide piece, a piece of felt prescribed in JIS L3201, test pieces cut out from the adhesive film so as to have the same amount of space are lubricously fixed so that the adhesive layers face each other. Therefore, the coefficient of kinetic friction thus obtained is a coefficient of kinetic friction between surfaces of adhesive layers.

<Grain Size Distribution and the Median Average Particle Diameter of the Lubricant>

The measurements were performed with use of an LA-300 manufactured by Horiba, Ltd.

### Example 1

### Example of Synthesis 1

### Synthesis of Polyamic Acid Serving as a Precursor of a Non-Thermoplastic Polyimide that is Contained in a Highly Heat-Resistant Polyimide Layer

Into a reaction vessel having a capacity of 350 L, 234 kg of dimethylformamide (DMF) and 19.9 kg of 2,2-bis[4-(4-aminophenoxy)phenyl]propane (BAPP) were poured and stirred. To the reaction solution, 3.9 kg of 3,3′,4,4′-benzophenone tetracarboxylic acid dianhydride (BTDA) were added, and then dissolved. After that, 6.9 kg of pyromellitic acid dianhydride (PMDA) were added, and then stirred for 30 minutes. Thus formed was a thermoplastic polyimide precursor block component.

In this solution, 7.9 kg of p-phenylenediamine (p-PDA) was dissolved. Then, to the solution, 16.1 kg of PMDA were added, and then dissolved by stirring the solution for one hour. Furthermore, to the solution, a DMF solution of PMDA (PMDA 0.8 kg/DMF 10.5 kg) prepared separately was carefully added, and the addition was stopped when the viscosity reached approximately 3,000 poise. Thus obtained was a precursor solution of a highly heat-resistant polyimide.

### Example of Synthesis 2

### Synthesis of Polyamic Acid Serving as a Precursor of a Thermoplastic Polyimide That is Contained in a Thermoplastic Polyimide Layer and the Addition of a Lubricant

Into a reaction vessel having a capacity of 350 L, 248 kg of dimethylformamide (DMF) and 17.5 kg of 3,3′,4,4′-biphenyl tetracarboxylic acid dianhydride (BPDA) were poured, and then stirred in a nitrogen atmosphere. To the solution, 41.4 g of 10 wt % DMF dispersion liquid of calcium hydrogen phosphate particles were added, and then stirred sufficiently. The calcium hydrogen phosphate particles had a median average particle diameter of 2 μm, and had such a grain size distribution that the percentage of particle diameter of not less than 7 μm was 0.05 wt %. Then, 24.0 kg of 2,2-bis[4-(4-aminophenoxy)phenyl]propane (BAPP) were gradually added. A solution was prepared separately by dissolving 0.5 kg of BPDA in 10 kg of DMF, and the solution was gradually added to and stirred in the reaction solution with attention paid to the viscosity. The addition and the stirring were stopped when the viscosity reached 400 poise. Thus obtained was a thermoplastic polyimide precursor solution having a lubricant dispersed therein.

<Manufacture of an Adhesive Film>

The polyamic acid solution, obtained in Example of Synthesis 1, which served as a precursor of a highly heat-resistant polyimide was caused to contain the following chemical dehydrating agent and catalyst:

Chemical dehydrating agent: 2.0 mol of acetic anhydride with respect to 1 mol of amic acid unit of the polyamic acid serving as a precursor of a highly heat-resistant polyimide

Catalyst: 0.5 mol of isoquinoline with respect to 1 mol of amic acid unit of the polyamic acid serving as a precursor of a highly heat-resistant polyimide

Then, the polyamic acid solution serving as a thermoplastic polyimide precursor and the polyamic acid solution serving as a highly heat-resistant polyimide precursor were extruded from a multimanifold three-layer coextrusion multilayer die (having a lip width of 650 mm), and then flow-cast onto an SUS endless belt, which was moving at 15 mm below the die, in such an order that the former formed outer layers and the latter formed an inner layer. Then, the multilayer film was heated at 130° C. for 100 seconds, and thus transformed into a self-supporting gel film. Furthermore, the self-supporting gel film was peeled away from the endless belt, held on with a tenter clip, and then dried and imidized at 300° C. for 16 seconds, at 400° C. for 29 seconds, and then at 500° C. for 17 seconds. Thus obtained was an adhesive film composed of a thermoplastic polyimide layer having a thickness of 2 μm, a highly heat-resistant polyimide layer having a thickness of 10 μm, and a thermoplastic polyimide layer having a thickness of 2 μm.

The adhesive film thus obtained was measured for the surface roughness Rmax of a surface of the adhesive film and the coefficient of kinetic friction between surfaces of the adhesive layers. Rmax was 0.7 μm, and the coefficient of kinetic friction was 0.6.

Further, the surfaces of the thermoplastic polyimide layers were observed with an optical microscope. As a result, it was confirmed that there existed projections formed by the lubricant. Of the projections formed by the lubricant, 100 projections were randomly sampled. Each of the projections was observed in detail at higher magnification. As a result, it was confirmed that 98 out of 100, i.e., 98% of the projections were covered with resin. Further, a cross-section of the adhesive film was observed with an SEM. As a result, it was confirmed that the highly heat-resistant polyimide layer had no center point of the lubricant and that the lubricant was dispersed in the thermoplastic polyimide resin.

<Manufacture of a Flexible Metal-Clad Laminate>

On both sides of the adhesive film thus obtained, 18-μm-thick rolled copper foil (BHY-22B-T; manufactured by Japan Energy Corporation) and then two protection materials (APICAL 125NPI; manufactured by Kaneka Corporation) were continuously laminated with heat under the following conditions: a laminating temperature of 380° C.; a polyimide film tension of 0.4 N/cm; a laminating pressure of 196 N/cm (20 kgf/cm); and a speed of lamination of 1.5 m/minute. Thus manufactured was a flexible metal-clad laminate. A surface of the flexible metal-clad laminate thus obtained was observed with a microscope. As a result, the metal foil was found to have no minute blisters on it.

### Comparative Example 1

An adhesive film and a flexible metal-clad laminate were manufactured in the same manner as in Example 1 except that 10 wt % DMF dispersion liquid of calcium hydrogen phosphate particles was not added to the polyamic acid serving as a precursor of a thermoplastic polyimide that is contained in a thermoplastic polyimide layer.

The adhesive film creased in process of manufacture, and made it impossible to obtain a flexible metal-clad laminate of good appearance.

Further, the adhesive film was measured for the surface roughness Rmax of a surface of the adhesive film and the coefficient of kinetic friction between surfaces of the adhesive layers. Rmax was 0.1 μm, and the coefficient of kinetic friction was 1.5.

The surfaces of the thermoplastic polyimide layers were observed with an optical microscope. As a result, it was confirmed that there existed no projections formed by the lubricant.

### Comparative Example 2

An adhesive film and a flexible metal-clad laminate were manufactured in the same manner as in Example 1 except that the calcium hydrogen phosphate particles used as the lubricant had a median average particle diameter of 11 μm.

The flexible metal-clad laminate had a surface on which several minute blisters were observed per area of 250 mm×250 mm.

Further, the adhesive film was measured for the surface roughness Rmax of a surface of the adhesive film and the coefficient of kinetic friction between surfaces of the adhesive layers. Rmax was 2.1 μm, and the coefficient of kinetic friction was 0.4.

Further, the surfaces of the thermoplastic polyimide layers were observed with an optical microscope. As a result, it was confirmed that there existed projections formed by the lubricant. Of the projections formed by the lubricant, 100 projections were randomly sampled. Each of the projections was observed in detail at higher magnification. As a result, it was confirmed that 75 out of 100, i.e., 75% of the projections were covered with resin. Further, a cross-section of the adhesive film was observed with an SEM. As a result, it was confirmed that the highly heat-resistant polyimide layer had no center point of the lubricant and that the lubricant was dispersed in the thermoplastic polyimide layers.

### Comparative Example 3

An adhesive film and a flexible metal-clad laminate were manufactured in the same manner as in Example 1 except that the calcium hydrogen phosphate particles used as the lubricant had a median average particle diameter of 0.7 μm.

The adhesive film creased in process of manufacture, and made it impossible to obtain a flexible metal-clad laminate of good appearance.

Further, the adhesive film was measured for the surface roughness Rmax of a surface of the adhesive film and the coefficient of kinetic friction between surfaces of the adhesive layers. Rmax was 0.2 μm, and the coefficient of kinetic friction was 1.0.

Further, the surfaces of the thermoplastic polyimide layers were observed with an optical microscope. As a result, it was confirmed that there existed projections formed by the lubricant. Of the projections formed by the lubricant, 100 projections were randomly sampled. Each of the projections was observed in detail at higher magnification. As a result, it was confirmed that 100 out of 100, i.e., 100% of the projections were covered with resin. Further, a cross-section of the adhesive film was observed with an SEM. As a result, it was confirmed that the highly heat-resistant polyimide layer had no center point of the lubricant and that the lubricant was dispersed in the thermoplastic polyimide layers.

Thus described is an adhesive film according to the present invention. However, the present invention is not limited to the description of the embodiments above, but may be carried out in many variations without the need for example, provided such variations do not exceed the scope of the description.

### INDUSTRIAL APPLICABILITY

As described above, an adhesive film according to the present invention is an adhesive film including: a highly heat-resistant polyimide layer; and thermoplastic polyimide layers, formed on both surfaces of the highly heat-resistant polyimide layer, each of the thermoplastic polyimide layers having a thickness of 1.7 μm to 7.0 μm, the thermoplastic polyimide layer having a lubricant dispersed therein or the thermoplastic polyimide layer and the highly heat-resistant polyimide layer having the lubricant dispersed so as to straddle therebetween, the lubricant having a median average particle diameter of 1 μm to 10 μm, the highly heat-resistant polyimide layer having substantially no center point of the lubricant, the thermoplastic polyimide layer having a surface on which the lubricant form projections covered with a thermoplastic polyimide resin.

This brings about an effect of providing an adhesive film, capable of achieving a reduction in lubricant with lubricity imparted thereto, which is free of minute blisters on metal foil thermally laminated thereon when the adhesive film is processed into an FPC for use in various electronic apparatuses. Therefore, the present invention makes it possible to provide an adhesive film that can be favorably used as an FPC even when a dense circuit pattern is formed. Furthermore, because of its high light transmittance, the adhesive film can be very favorably inspected by light transmission for detecting defects and positioning circuits.

Therefore, the present invention can be suitably applied not only to chemical and resin industries for manufacture of adhesive films, but also to electronic component industries using FPCs and the like, and further to electrical and electronic apparatus industries using electronic components.

1. An adhesive film comprising:
a highly heat-resistant polyimide layer which contains a non-thermoplastic polyimide and/or a precursor thereof, and
thermoplastic polyimide layers, formed on both surfaces of the highly heat-resistant polyimide layer, each of which contains a thermoplastic polyimide and/or a precursor thereof,
each of the thermoplastic polyimide layers having a thickness of 1.7 μm to 7.0 μm,
the thermoplastic polyimide layer having a lubricant dispersed therein or the thermoplastic polyimide layer and the highly heat-resistant polyimide layer having the lubricant dispersed so as to straddle therebetween, the lubricant having a median average particle diameter of 1 μm to 10 μm,
the highly heat-resistant polyimide layer having substantially no center point of the lubricant,
the thermoplastic polyimide layer having a surface on which the lubricant form projections covered with a thermoplastic polyimide resin.

2. The adhesive film as set forth in claim 1, wherein the surface of the thermoplastic polyimide layer has a surface roughness Rmax of less than 2 μm.

3. The adhesive film as set forth in claim 1, wherein a coefficient of kinetic friction between the surfaces of the thermoplastic polyimide layers is less than 0.8.

4. The adhesive film as set forth in claim 1, wherein the adhesive film is manufactured by a coextrusion-casting coating method.
